(19) United States
(12) Patent Application Publication
(10) Pub. No.: US 2020/0132135 A1
(43) Pub. Date: Apr. 30, 2020

(54) FRICTION CLUTCH

(71) Applicant: Schaeffler Technologies AG & Co. KG, Herzogenaurach (DE)

(72) Inventor: Sebastian Heuberger, Bühl (DE)

(73) Assignee: Schaeffler Technologies AG & Co. KG, Herzogenaurach (DE)

(21) Appl. No.: 16/629,194

(22) PCT Filed: Jul. 3, 2018
(86) PCT No.: PCT/DE2018/100604

§ 371 Date: Jan. 7, 2020

(30) Foreign Application Priority Data
Jul. 7, 2017 (DE) 10 2017 115 210.5

(51) Int. Cl. F16D 43/04; F16D 13/52; F16D 23/12; F16D 13/58

(52) U.S. Cl. CPC F16D 43/04; F16D 13/52; F16D 2023/123; F16D 13/583; F16D 23/12

(57) ABSTRACT

A friction clutch for a drivetrain includes an input shaft, an output shaft, a compressible friction pack including a normally closed spring system, and an actuating device. The compressible friction pack is for transmitting a torque between the input shaft and the output shaft in a closed state of the friction clutch. The actuating device is for producing an axial actuating force to compress the compressible friction pack. The actuating device includes an opening spring for exerting an opening force, a centrifugal mass unit including a ramp, and a switching element including a counterpart ramp. The centrifugal mass unit is movable through a radial travel at a predetermined rotational speed of the input shaft. The ramp and the counterpart ramp form a ramp pairing with a ramp gradient to convert the radial travel into the axial actuating force acting counter to the opening force to compress the compressible friction pack.

### CROSS-REFERENCE TO RELATED APPLICATIONS

This application is the United States National Phase of PCT Appln. No. PCT/DE2018/100604 filed Jul. 3, 2018, which claims priority to German Application No. DE102017115210.5 filed Jul. 7, 2017, the entire disclosures of which are incorporated by reference herein.

### TECHNICAL FIELD

The disclosure relates to a friction clutch having an axis of rotation for a drivetrain, to a drivetrain and to a motor vehicle having a friction clutch of this kind.

### BACKGROUND

Semiautomatic friction clutches are known from the prior art, e.g. for motorcycles, in which use is made of centrifugal masses, with the result that the friction clutch is closed when a predetermined rotational speed is applied. For this purpose, it is necessary that the friction clutch to be closed should be normally open, with the result that the friction clutch is open when the rotational speed applied is below the predetermined rotational speed, that is to say when the centrifugal masses return to their initial position, and the centrifugal masses close the friction clutches only when a predetermined rotational speed is applied.

However, a normally-open friction clutch can be difficult to measure because, to check the torque that can be transmitted, the normally-open friction clutch must be closed in the measuring rig by means of a corresponding closing device belonging to the measuring rig, and the closing device does not necessarily coincide with the closing device in the subsequent use of the normally-open friction clutch.

### SUMMARY

The disclosure relates to a friction clutch, having an axis of rotation, for a drivetrain, having at least the following components: an input shaft; an output shaft; a compressible friction pack for transmitting a torque between the input shaft and the output shaft in the closed state of the friction clutch; and an actuating device for producing an axial actuating force to compress the friction pack. The actuating device includes at least one centrifugal mass unit and at least one switching element, and the centrifugal mass unit and the switching element form a ramp pairing with a ramp gradient between a ramp and a corresponding counterpart ramp. By application of a predetermined rotational speed, the input shaft of the centrifugal mass unit can be forced to move through a radial travel, and thus, by means of the ramp pairing, said radial travel can be converted into the axial actuating force. The friction clutch is characterized in that the friction pack has a normally-closed friction clutch configuration by means of a normally-closed spring system, and the actuating device has an opening spring which exerts an antagonistic opening force. The ramp pairing is designed to act counter to the opening force of the opening spring as a result of the predetermined rotational speed, in order to compress the friction pack.

The friction clutch is designed to transmit a torque in a disconnectable manner from a driven shaft to a consuming unit and vice versa. In general, this is achieved by means of the (at least one) friction pack, which, according to one embodiment, has an axially movable pressure plate that is generally fixed in terms of rotation relative to the driven shaft and that can be pressed against at least one corresponding friction disk. In another embodiment, the friction pack is formed by means of a lamella pack. In the lamella pack, input-side friction lamellae, which are fitted in an input cage in such a way that they are fixed in the direction of revolution and are axially movable, and output-side friction lamellae, which are fitted in an output cage in such a way that they are fixed in the direction of revolution and are axially movable, are provided alternately. These lamellae can be pressed together and, with each contact surface between the lamellae, form a cumulative total friction surface. The pressing force results in a frictional force over the (total) friction surface which, when multiplied by the mean radius of the (total) friction surface, gives a transmissible torque.

The friction clutch proposed here is balanced relative to its axis of rotation. Reference will be made to this axis of rotation below where mention is made of the axial direction, the radial direction or the direction of revolution.

The friction clutch is incorporated into a drivetrain, wherein a torque can be transmitted switchably from the input shaft to the output shaft and vice versa, e.g. in the overrun mode. In many cases, the input shaft is at least indirectly connected to or formed integrally with a driven shaft, and the output shaft is at least indirectly connected to a consuming unit.

In an example embodiment, at least one of the two shafts, e.g., the output shaft, is rigidly connected to a manual transmission. The manual transmission is designed to enable a different transmission ratio of the torque to be set. Shifting of the manual transmission, i.e. changing of the transmission gear, is preferably possible only in the open state of the friction clutch, i.e. when the friction pack is not compressed, and therefore no opposing torques are applied to the manual transmission during a shifting process.

In the case of a conventional configuration, the friction pack is normally open. That is to say that, when there is no actuation by means of the actuating device, no torque or only a sufficiently low torque is transmitted.

The actuating device includes at least one centrifugal mass unit, which may have a plurality of centrifugal masses, e.g. three centrifugal masses. The centrifugal masses are arranged in axial symmetry and travel outward along a respective guided radial path when a predetermined rotational speed is applied. Only one of the centrifugal masses is described in each case below, wherein, in the case of a plurality of centrifugal masses which each form a centrifugal mass unit, the other centrifugal masses in each case operate in the same way or in a similar way. For example, the centrifugal masses of a centrifugal mass unit rest against one another in the direction of revolution and move apart when they follow the respective radial path outward.

The centrifugal mass interacts with a switching element, which performs an axial stroke due to the movement of the centrifugal mass along the radial path thereof. The switching element may be embodied in an integral manner and interacts with the total number of centrifugal masses of a (single) centrifugal mass unit. As an alternative, the switching element is of multi-part design.

The axial stroke and the resulting actuating force of the switching element results directly (as a pressing force) or indirectly (in interaction with a spring system, lever system or the like) in compression of the friction pack. The conversion of the direction of movement of the centrifugal mass into the axial stroke is achieved by means of a ramp pairing, which is formed between the centrifugal mass and the switching element and which has a ramp gradient. The ramp gradient results from the geometry of the ramp and the geometry of the corresponding counterpart ramp and is designed for a suitable pressing process in accordance with the applied rotational speed and the mass of the centrifugal masses. Thus, control of the actuating device takes place via the input shaft and the rotational speed thereof, and therefore the input shaft is in most cases connected to a drive assembly.

If a predetermined rotational speed, e.g. 9000 rpm [revolutions per minute], is reached from a lower rotational speed, the centrifugal mass moves through a radial travel, which results in sufficiently powerful compression of the friction pack, thus enabling a predetermined torque, e.g. 29 Nm [Newton meters] in the traction mode and 10 Nm in the overrun mode, to be transmitted from the input shaft to the output shaft (e.g. in the traction mode) or vice versa (e.g. in the overrun mode) by means of the friction clutch.

In contrast to the previously known use of a friction pack with normally-open friction clutch configurations, the proposal here is now to embody the friction pack with a normally-closed spring system. A normally-closed spring system of this kind is, for example, a leaf spring system, by means of which the friction surfaces are pressed together in the unactuated state of the friction pack. Thus, the friction pack is embodied as a normally-closed friction clutch configuration.

Moreover, an opening spring is provided, which is designed in such a way that it counteracts the closing force of the normally-closed friction pack with an antagonistic opening force. This results overall in a normally-open friction clutch configuration. As a particular preference, the opening spring is embodied as a diaphragm spring, which develops a large axial force in a small axial installation space and, on the basis of the intrinsic lever configuration, allows force multiplication by virtue of a suitable design of the force application point or force application line.

The opening spring is a component part of the actuating device in addition to the at least one centrifugal mass unit and the at least one switching element. When viewed in terms of constructional unity for assembly, it is likewise possible to regard the opening spring as a component part of the normally-closed friction pack or to embody it as a constructional unit with the friction pack. The normally-closed spring system of the normally-closed friction pack is embodied by means of leaf springs, as tension springs, for example. Use can be made of a friction pack which is configured and designed for the corresponding drivetrain for actuation by hand or actuation by foot, i.e. manual actuation. For one construction series of a drivetrain, e.g. of a scooter, with the same driving power it is thus possible to use the same friction pack for a manually actuable model and a semi-automatically actuable model.

The at least one ramp pairing counteracts the opening spring or the opening force of the opening spring when the predetermined rotational speed is applied, causing the friction pack to close.

As a result, it is possible to use a conventional friction pack for manual actuation that can be checked in a conventional test rig, just like a conventional friction pack. The additionally required opening spring needs only a small axial installation space, especially when using a diaphragm spring as an opening spring. In this case, an implementation that is neutral in terms of installation space is possible since the normally-closed spring system can be simplified and can be of smaller construction because the following negative effects with a normally-open friction clutch configuration of the friction pack are eliminated:

In the normally-open friction clutch configuration, the leaf springs are antagonists of the actuating unit and therefore reduce the compression spring preload, thereby necessitating a more powerful design thereof. However, because the installation space is limited, a high stiffness must be employed. During release, the (very stiff) compression spring and (very stiff) leaf spring must be moved, resulting in an increased release force. Moreover, the leaf spring must be further lengthened for the wear position, thereby further reducing the effective compression spring force. Overall, therefore, this gives a friction clutch with improved utilization of material and utilization of force.

According to an example embodiment of the friction clutch, the friction pack is compressed exclusively by means of the normally-closed spring system in the closed state. In this embodiment, the ramp pairing of the actuating device merely cancels out the opening force of the opening spring. Thus, the force to be exerted by the ramp pairing to actuate the friction clutch is significantly reduced and lighter centrifugal masses can be used. Moreover, the reliability of closure, i.e. the pressing force in the closed state of the friction pack, depends exclusively on the design of the normally-closed spring system. This, in turn, can be designed to be like that of a manually actuated friction clutch.

According to an example embodiment of the friction clutch, the ramp pairing is of multistage design, with the result that the ramp gradient is variable over the radial travel of the centrifugal mass unit, and the opening force of the opening spring can be canceled only by means of the actuating device. In an example embodiment, the multistage ramp pairing is the only ramp pairing of the actuating device.

In this friction clutch, it is now proposed that the ramp pairing between the centrifugal mass and the switching element should be of multistage design. This means that the ramp gradient is different at an initial point of the radial travel of the centrifugal mass from that in another section, e.g., at the end of the radial travel. This ensures that engagement is achievable only at a high rotational speed or, alternatively, a rapid increase or decrease in the pressing force is achievable in a variable manner over the radial travel of the centrifugal mass. This variability is therefore not dependent on the provision of a further centrifugal mass unit (e.g. on the transmission side) but can be achieved by means of a single centrifugal mass unit.

The friction clutch may have just this single actuating device, as described above, and just this single ramp pairing is provided in this actuating device. By means of its multistage design, this single ramp pairing performs the task of the conventionally provided two actuating devices or ramp pairings of a motor-side centrifugal mass unit and of a transmission-side centrifugal mass unit. The ramp gradient may be designed in such a way that engagement takes place only at a high rotational speed and that, at the same time, disengagement takes place only at a rotational speed after the idling speed when a friction clutch is closed. It may once again be pointed out that the friction pack can be compressed directly or indirectly by means of the actuating device.

In an example configuration, the axial total overall length is less than with a conventional friction clutch having two centrifugal mass units.

According to an example embodiment of the friction clutch, the ramp is formed by means of the centrifugal mass unit, and the corresponding counterpart ramp is formed by means of the switching element. The counterpart ramp may have a first partial ramp having a first ramp slope and a second partial ramp radially to the outside of the first partial ramp, having a second ramp slope, wherein the second ramp slope may be less than the first ramp slope.

In this embodiment, the ramp gradient is divided into a first ramp slope and a second ramp slope, and the counterpart ramp is formed by the switching element in that the counterpart ramp is divided into a first partial ramp and a second partial ramp. The transition between the first partial ramp and the second partial ramp may be gentle, being formed by means of a radius for example.

The first partial ramp has a steep rise, thereby converting the resultant centrifugal force into a relatively small driving force, e.g. with a 45° gradient with the factor close to 1. The second ramp slope is of relatively shallow design, and therefore the resultant centrifugal force is converted, e.g., multiplied, into a relatively large driving force, e.g. with a 60° gradient with a factor of about 3.1. It is thus ensured that the friction clutch is held closed.

It may be pointed out at this point that the switching element may be of rigid design and gives way to the radial movement of the centrifugal masses only by means of the overall movement of the switching element with the axial stroke. Deformations are negligible during this process. As an alternative, the switching element is of flexible design and produces the axial stroke by virtue of an elastic deformation. In this alternative embodiment, the ramp slope of the partial ramps must accordingly be designed to match the respective state of elastic deformation dependent on the radial position of the centrifugal mass.

According to an example embodiment of the friction clutch, the opening spring is a diaphragm spring, which is supported on the outer edge thereof and acts by means of the inner edge thereof on the friction pack, and the ramp pairing is designed to exert an antagonistic effect on the diaphragm spring in an intermediate region between the outer edge and the inner edge.

In this embodiment, a particularly simple construction and the lever action of the diaphragm spring can be utilized. The precise force application line or force application points in the intermediate region of the diaphragm spring must be designed according to the requirements on the drivetrain, e.g. in accordance with the desired pressing force and the required predetermined rotational speed for the compression and opening of the friction pack. The support for the outer edge of the diaphragm spring may be formed by means of a flange or by means of a plurality of stepped bolts of the clutch cage or of the lamella cage, with the result that the diaphragm spring rotates along with the actuating device and there is no need to provide an additional component.

According to another aspect, the disclosure relates to a drivetrain having a drive assembly with a driven shaft, at least one consuming unit and a friction clutch according to one embodiment as per the above description. The driven shaft can be connected to the at least one consuming unit by means of the friction clutch for torque transmission with a variable transmission ratio.

The drivetrain is designed to transmit a torque, which is supplied by a drive assembly, e.g. an energy conversion machine, for example an internal combustion engine or an electric motor, and is output via the driven shaft thereof, for at least one consuming unit in a disconnectable manner, i.e. in such a way that it can be connected up and disconnected. An illustrative consuming unit is at least one driven wheel of a motor vehicle and/or an electric generator for supplying electric energy. Conversely, it is also possible to implement absorption of inertial energy introduced by a driven wheel, for example. The at least one driven wheel then forms the drive assembly, and the inertial energy thereof can be transferred by means of the friction clutch to an electric generator for energy recovery, i.e. for electric storage of the braking energy, with a correspondingly designed drivetrain. In an example embodiment, a plurality of drive assemblies is furthermore provided, which can be operated in such a way as to be connected in series or in parallel or to be decoupled from one another by means of the friction clutch, or the torque of which can in each case be made available for use in a disconnectable way. Examples are hybrid drives comprising an electric motor and an internal combustion engine, but also multicylinder engines, in which individual cylinders (cylinder groups) can be connected up.

In order to transmit the torque selectively and/or with different ratios by means of a manual transmission or to disconnect transmission, the use of the friction clutch described above may be advantageous. The drivetrain proposed here has a friction clutch of simple construction using a friction pack that has already been developed and, under certain circumstances, even a diaphragm spring that has already been developed. The drivetrain may have a particularly high efficiency because the number of rotating masses, and especially large co-rotating centrifugal masses, for which furthermore a suitable retainer, e.g. for a catastrophic resonance event, must be provided, are reduced. Moreover, it is possible to gain axial installation space which can be used for other assemblies in the drivetrain or whereby the overall structure of the drivetrain is reduced.

According to another aspect, the disclosure relates to a motor vehicle having at least one driven wheel, which can be driven by means of a drivetrain according to one embodiment as per the above description.

Nowadays, most motor vehicles have front-wheel-drive and therefore often place the drive assembly, e.g. an internal combustion engine or an electric motor, in front of the driver's cab and transversely to the main direction of travel. Precisely in such an arrangement, the installation space is particularly small and the use of a friction clutch with a small overall size is therefore advantageous. The situation is similar with the use of a friction clutch in motorcycles, for which significantly enhanced power for the same installation space is required.

The drivetrain described above has a friction clutch by means of which a simple friction pack construction that can be reliably checked is made possible.

### BRIEF DESCRIPTION OF THE DRAWINGS

The disclosure described above is explained in detail below in relation to the relevant technical background, with reference to the associated drawings, which show example embodiments. The disclosure is not in any way restricted by the purely schematic drawings, and it should be noted that the drawings are not to scale and are not suitable for defining size ratios. In the drawings:

FIG. 1 shows a friction clutch having two centrifugal mass units in section;

FIG. 2 shows a friction clutch having a single centrifugal mass unit in section;

FIG. 3 shows a force/spring travel diagram of a friction clutch with a normally-closed friction pack;

FIG. 4 shows a torque transmission diagram as a function of the rotational speed with a friction clutch having two centrifugal mass units;

FIG. 5 shows a centrifugal mass unit in section with two partial ramps in the engaged position; and

FIG. 6 shows a drivetrain in a motor vehicle having a friction clutch.

### DETAILED DESCRIPTION

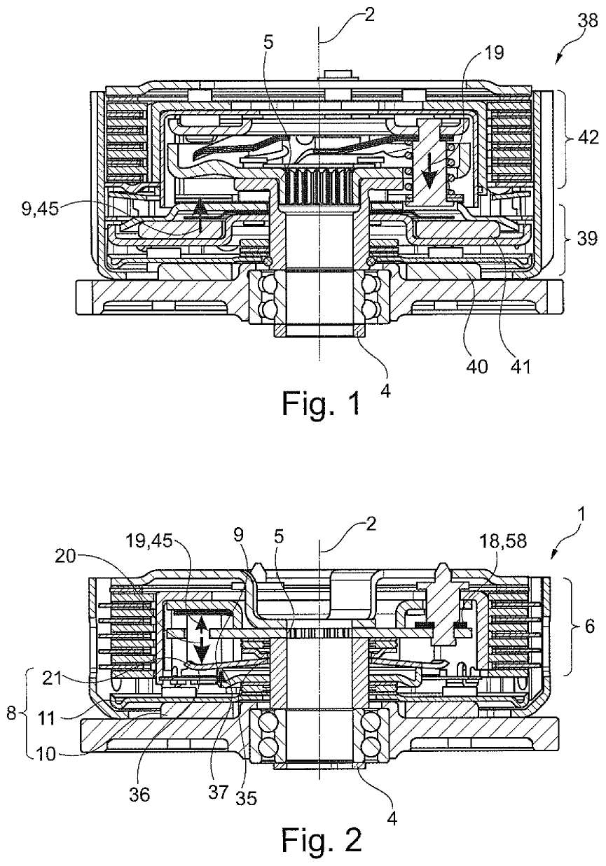

FIG. 1 shows a friction clutch 38 having two centrifugal mass units and having an axis of rotation 2, in which a friction pack 42 is provided. This friction pack 42 is embodied as a normally-open lamella pack. This friction clutch 38 switchably connects an input shaft 4 to an output shaft 5 along the axis of rotation 2, depending on the input speed of rotation, i.e. semiautomatically. To close the friction pack 42, a first centrifugal mass unit 40 and a second centrifugal mass unit 41 of an actuating device 39 are provided. In this arrangement, the first centrifugal mass unit 40 is connected to the input shaft 4, with the result that the friction pack 42 is compressed when a predetermined rotational speed is applied to the input shaft 4. The second centrifugal mass unit 41 is connected to the output shaft 5, and therefore the closure of the friction pack 42 is assisted by the second centrifugal mass unit 41 only when the input shaft 4 is synchronized with the output shaft 5.

FIG. 2 illustrates a friction clutch 1 having an actuating device 8, which comprises only a single centrifugal mass unit 10. In this case, the actuating device 8 is furthermore equipped with an opening spring 21 because, in this case, a friction pack 6 has a normally-closed friction clutch configuration. By means of a normally-closed spring system 18, in this case by means of leaf springs 58, the friction pack 6 thus exerts the pressing force 45 in the unactuated state, as a result of which the friction pack 6 is compressed and a predetermined traction torque 52 (ref. FIG. 4) can be transmitted. The opening spring 21, in this case embodied as a diaphragm spring, rests with its inner edge supported on the output shaft 5 and, by means of its outer edge 36, acts on the friction pack 6, in this case by means of a stepped bolt, in a manner antagonistic to the normally-closed spring system 18.

The opening spring 21 is therefore designed to open the friction pack 6 in the state of rest, i.e. normally. Overall, therefore, the friction clutch 1 has a normally-open friction clutch configuration. If there is a rotational speed below a predetermined rotational speed 16 (ref. FIG. 4), the friction pack 6 is open. When a predetermined rotational speed 16 is applied, the centrifugal mass unit 10 interacts with the switching element 11 to counter the opening force 20 of the opening spring 21, with the result that the friction pack 6 closes automatically without the action of the actuating force 9, i.e. due to the movement of the centrifugal mass unit 10. In the closed state, the input shaft 4 and the output shaft 5 are synchronous or synchronized with one another.

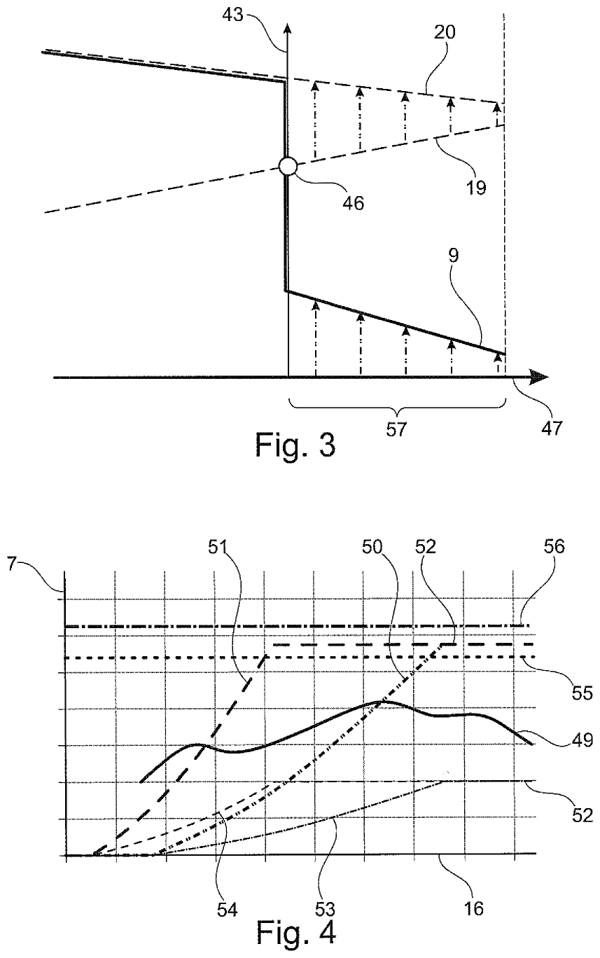

FIG. 3 illustrates a diagram of the force variation against the spring travel. The vertical axis shows the force 43 and the transverse axis shows the spring travel 47. In the region of the release process 57, i.e. on the right of the operating point 46 in the diagram, the friction pack is held closed by means of the normally-closed spring force 19. This is counteracted by the (larger) opening force 20 of the opening spring 21 (ref. FIG. 2), which holds the friction pack open on the left of the operating point 46. At the operating point 46, synchronization of the friction partners of the friction pack, referred to as “clutch slip”, takes place. The operating point 46 is therefore the point of transition from open to closed. Here, there is no travel before the necessary pressing force has been built up. Owing to the fixing of the normally-closed spring system 18 (ref. FIG. 2) to one friction partner of the friction pack, e.g. the inner cage, and to the engagement of the opening spring 21 on the opposite corresponding friction partner, e.g. the outer cage, the normally-closed spring force 19 engages only when the opening spring 21 is released to such an extent that the (slipping) plane of the operating point 46 is reached. To engage the friction pack, the opening force 20 must first of all be overcome by means of the centrifugal mass unit alone, without assistance from the normally-closed spring force 19. Only in the closed state does the normally-closed spring force 19 engage, and only a small actuating force 9 is required to keep the friction pack closed.

FIG. 4 shows a torque transmission diagram of the semiautomatic friction clutch, wherein a transmissible torque 7 is illustrated as a function of the rotational speed 16. The figure furthermore shows, by way of example, a torque characteristic 49 of a drive assembly, which is below a lower safety limit 55 and an upper safety limit 56, and therefore the output torque can be transmitted safely by means of the friction clutch. When driving away, the transmissible traction torque 48 is achieved only at a high rotational speed 16 in accordance with the profile of the closing traction torque rise 50, and therefore driving away takes place only when a high rotational speed is present. As soon as the input shaft and the output shaft are synchronized with one another, the rotational speed required to open the friction clutch shifts to a lower range. Moreover, the friction clutch is opened more quickly, i.e. above a lower rotational speed range, namely along the profile of the opening traction torque rise 51. In the overrun mode, only a lower torque can be transmitted, namely the overrun torque 52, wherein the respective limiting rotational speeds on the profile of the closing overrun torque rise 53 and the opening overrun torque rise 54, respectively, of the overrun mode are at the same rotational speeds 16 in comparison with the traction mode.

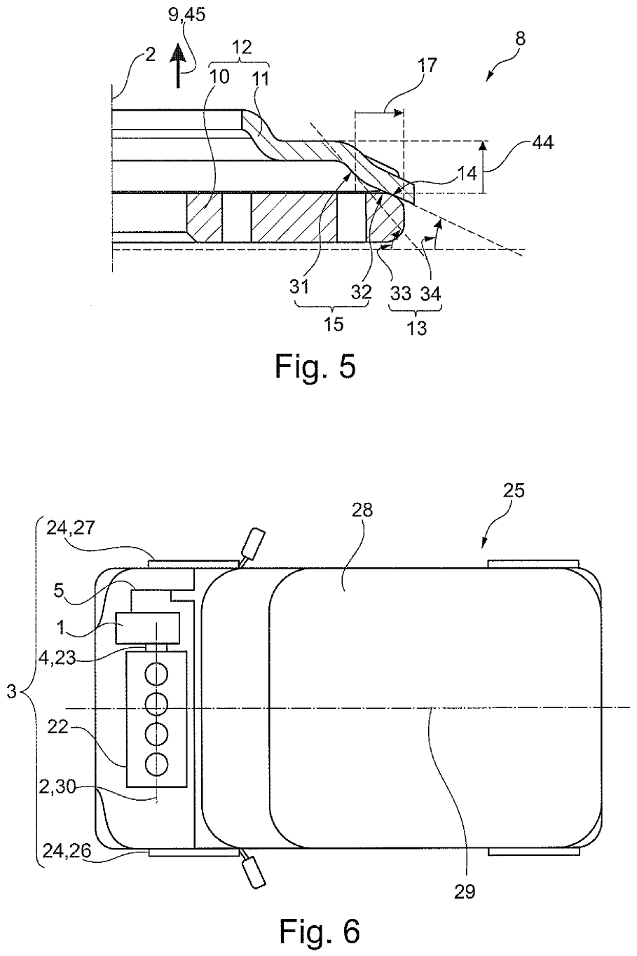

FIG. 5 shows (at least a section of) an actuating device 8, in which a switching element 11 forms a ramp pairing 12 together with a centrifugal mass unit 10. The centrifugal mass unit 10, or the centrifugal mass shown here, moves outward away from the axis of rotation 2 along the radial travel 17. The centrifugal mass unit 10 is situated in an end position at the end of the radial travel 17. The centrifugal mass unit 10 has a ramp 14, and the switching element 11 has a corresponding counterpart ramp 15. The counterpart ramp 15 is subdivided into a first partial ramp 31 and a second partial ramp 32. The ramp gradient 13 of the counterpart ramp 15 is thereby divided into two sections, namely with the first ramp slope 33 on the first partial ramp 31 and with the second ramp slope 34 on the second partial ramp 32.

On the first partial ramp 31, the first ramp slope 33 is steeper than the second ramp slope 34, and therefore the centrifugal mass unit 10 must produce a higher centrifugal force on a first section of the radial travel 17 to force the switching element 11 axially, i.e. in the direction of the opening travel 44. This results in closure of the friction pack (cf. FIG. 2) only at a higher rotational speed than if the first ramp slope 33 were of shallower configuration, as is the case with the second partial ramp 32 for example.

As illustrated here, the centrifugal mass unit 10 rests on the second partial ramp 32 with the second ramp slope 34, and the second ramp slope 34 is shallower than the first ramp slope 33. As a result, a lower rotational speed is now required to hold the centrifugal mass unit 10 in the illustrated position at the end of the radial travel 17 and to produce the required pressing force 45 or actuating force 9. This effect thus corresponds to the use of a higher mass at a constant ramp slope. For this reason, the practice hitherto has been to use a second centrifugal mass unit with, furthermore, a higher mass on the transmission side. It may be pointed out here that this actuating device 8 can be used both with a friction pack 42 of the kind shown in FIG. 1 and a friction pack 6 of the kind shown in FIG. 2. It may also be pointed out that the actuating device 8 shown can furthermore comprise a second centrifugal mass unit and/or a diaphragm spring.

In FIG. 6, a drivetrain 3 comprising a drive assembly 22, here in the form of an internal combustion engine, a driven shaft 23 (input shaft 4), a friction clutch 1 and a consuming unit 24 forming a left-hand driven wheel 26 and a right-hand driven wheel 27 connected in a torque-transmitting manner by means of output shaft 5, is illustrated schematically. Here, the drivetrain 3 is arranged in a motor vehicle 25, wherein the drive assembly 22 is arranged with its motor axis 30 (axis of rotation 2) transversely to the longitudinal axis 29, in front of the driver's cab 28.

A construction of a semiautomatic actuating system that is simple and simple to check is made possible with the friction clutch proposed here.

### LIST OF REFERENCE SIGNS

1 friction clutch
2 axis of rotation
3 drivetrain
4 input shaft
5 output shaft
6 friction pack
7 torque
8 actuating device
9 actuating force
10 centrifugal mass unit
11 switching element
12 ramp pairing
13 ramp gradient
14 ramp
15 counterpart ramp
16 rotational speed
17 radial travel
18 normally-closed spring system
19 normally-closed spring force
20 opening force
21 opening spring
22 drive assembly
23 driven shaft
24 consuming unit
25 motor vehicle
26 left-hand driven wheel
27 right-hand driven wheel
28 driver's cab
29 longitudinal axis
30 motor axis
31 first partial ramp
32 second partial ramp
33 first ramp slope
34 second ramp slope
35 inner edge of the diaphragm spring
36 outer edge of the diaphragm spring
37 intermediate region of the diaphragm spring
38 friction clutch having two centrifugal mass units
39 actuating device having two centrifugal mass units
40 first centrifugal mass unit
41 second centrifugal mass unit
42 normally-open friction pack
43 force
44 opening travel
45 pressing force
46 operating point
47 spring travel
48 transmissible traction torque
49 torque characteristic
50 closing traction torque rise
51 opening traction torque rise
52 transmissible overrun torque
53 closing overrun torque rise
54 opening overrun torque rise
55 lower safety limit
56 upper safety limit
57 release process
58 leaf springs

1.-7. (canceled)

8. A friction clutch for a drivetrain, comprising:
an axis of rotation;
an input shaft;
an output shaft;
a compressible friction pack, comprising a normally closed spring system, for transmitting a torque between the input shaft and the output shaft in a closed state of the friction clutch; and
an actuating device for producing an axial actuating force to compress the compressible friction pack, the actuating device comprising:
an opening spring for exerting an opening force;
a centrifugal mass unit, comprising a ramp, movable through a radial travel at a predetermined rotational speed of the input shaft; and
a switching element comprising a counterpart ramp that, together with the ramp, forms a ramp pairing comprising a ramp gradient to convert the radial travel into the axial actuating force acting counter to the opening force to compress the compressible friction pack.

9. The friction clutch of claim 8, wherein the compressible friction pack is only compressed by the normally closed spring system in the closed state.

10. The friction clutch of claim 8, wherein:
the ramp pairing is of multistage design and is the only ramp pairing of the actuating device;
the ramp gradient is variable over the radial travel of the centrifugal mass unit; and
the opening force can only be overcome by the actuating device.

11. The friction clutch of claim 10, wherein:
the ramp is formed by the centrifugal mass unit;
the counterpart ramp is formed by the switching element; and
the counterpart ramp comprises:
a first partial ramp comprising a first ramp slope; and
a second partial ramp, radially outside of the first partial ramp, comprising a second ramp slope less than the first ramp slope.

12. The friction clutch of claim 8, wherein:
the opening spring is a diaphragm spring comprising:
an outer edge;
an inner edge; and
an intermediate region between the outer edge and the inner edge;
the diaphragm spring is supported on the outer edge;
the inner edge operates on the compressible friction pack; and
that axial actuating force acts on the intermediate region.

13. A drivetrain comprising:
the friction clutch of claim 8;
a consuming unit; and
a drive assembly comprising a driven shaft, wherein the driven shaft is connectable to the consuming unit by the friction clutch for torque transmission with a variable transmission ratio.

14. A motor vehicle comprising a driven wheel drivable by the drivetrain of claim 13.
